(19) United States
(12) Patent Application Publication
(10) Pub. No.: US 2019/0062625 A1
(43) Pub. Date: Feb. 28, 2019

(54) PHOTOCHROMIC MOLECULE-CYCLODEXTRIN INCLUSION COMPOUNDS AND METHOD FOR MAKING SAME

(71) Applicant: HON HAI PRECISION INDUSTRY CO., LTD., New Taipei (TW)

(72) Inventor: HSIU-WEN CHIEN, New Taipei (TW)

(21) Appl. No.: 15/702,874

(22) Filed: Sep. 13, 2017

(30) Foreign Application Priority Data
Aug. 22, 2017 (TW) 106128480

(51) Int. Cl. C09K 9/02; C08B 37/16; G02B 1/04

(52) U.S. Cl. CPC C09K 9/02; C08B 37/0015; C09K 2211/1475; C09K 2211/145; G02B 1/041

(57) ABSTRACT

A method for making photochromic molecule-cyclodextrin inclusion compounds, including: preparing a solution of photochromic molecules and preparing a solution of cyclodextrins. The molecule of cyclodextrin is frusto-conical shaped and hollow. The photochromic solution and the cyclodextrin solution are mixed, the photochromic molecules being entrapped in the cavities of the cyclodextrins, thereby forming the photochromic molecule-cyclodextrin inclusion compounds.

### FIELD

The subject matter herein generally relates to photochromic molecule-cyclodextrin inclusion compounds, and a method for making the same.

### BACKGROUND

Photochromic molecules have the ability to darken when exposed to light (such as sunlight), and recover to original state when the light is removed. That would make the photochromic molecules useful in ophthalmic lens or other bionic products but the photochromic molecule materials are hydrophobic.

### BRIEF DESCRIPTION OF THE DRAWINGS

Implementations of the present technology will now be described, by way of example only, with reference to the attached figures.

FIG. 1 is a flowchart of an exemplary embodiment of a method for making photochromic molecule-cyclodextrin inclusion compounds.

FIG. 2 is a model diagram of an exemplary embodiment of cyclodextrins.

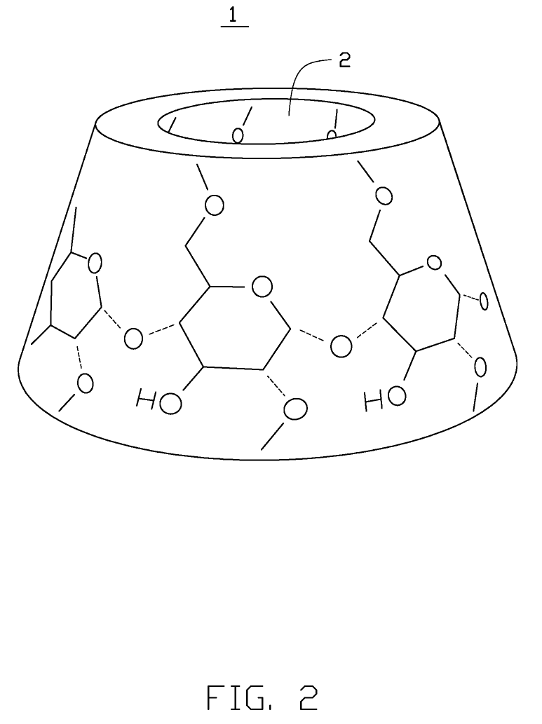

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

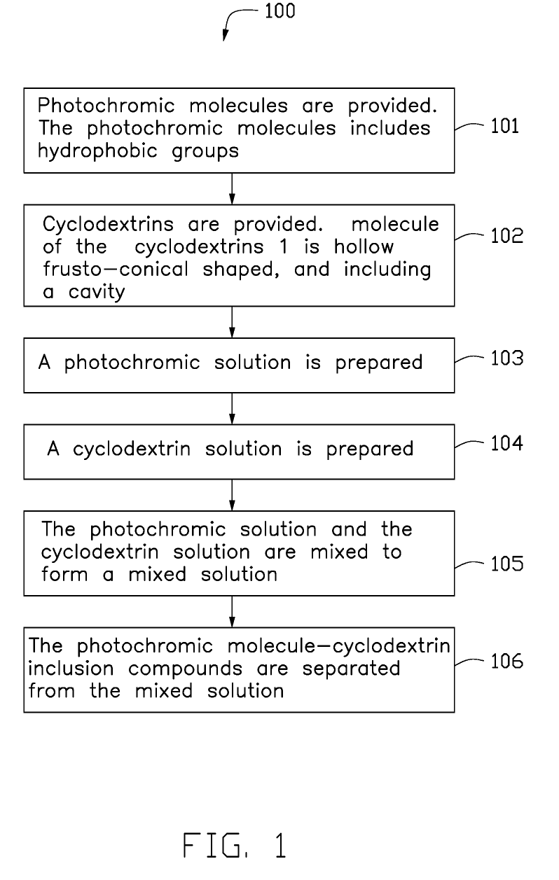

FIG. 1 illustrates a flowchart of an embodiment for a method for making photochromic molecule-cyclodextrin inclusion compounds. The exemplary method is provided by way of example, as there are a variety of ways to carry out the method. Each block shown in the figure represents one or more processes, methods, or subroutines, carried out in the exemplary method. Furthermore, the illustrated order of blocks is by example only, and the order of the blocks can change. Additional blocks may be added or fewer blocks may be utilized, without departing from this disclosure. The exemplary method can begin at block 101.

At block 101, photochromic molecules are provided. The photochromic molecules includes hydrophobic groups.

In at least one exemplary embodiment, the photochromic molecules can be selected from a group consisting of spiropyrans, spiroperimidines, diarylethenes, fulgides, hexaarylbiimidazole, azobenzenes, benzopyrylospiran, and any combination thereof.

At block 102, cyclodextrins are provided. Referring to FIG. 1, a molecule of cyclodextrin 1 is hollow frusto-conical shaped, and includes a cavity 2.

The cyclodextrin can be α-cyclodextrins, β-cyclodextrins, γ-cyclodextrins, cyclodextrin derivatives, or any combination thereof.

Cyclodextrins are a generic term for a series of cyclic oligosaccharides produced by amylose reacted under cyclodextrin glucosyltransferase produced by bacillus. Cyclodextrins usually contains 6 to 12 D-glucopyranose units. Based on the results of X-ray crystallography, infrared spectroscopy and nuclear magnetic resonance spectroscopy, each glucopyranose unit constituting a cyclodextrin molecule is a chair or stool configuration. Each glucose unit is bound to a ring with 1,4-glycosidic bonds. Since glucosidic linkages connecting the glucose units are not free to rotate, the cyclodextrin molecule is not a cylindrical molecule but is slightly conical, i.e., a hollow frustum (see FIG. 1). The hydrophilic functional group, such as a hydroxyl group, is located on outside of a hollow frusto cone of the cyclodextrin molecule, a secondary hydroxyl group is located at a larger open end of the hollow frusto cone, and a primary hydroxyl group is located at a smaller open end of the hollow frusto cone. Interior of the hollow frusto cone has relative hydrophobicity.

In at least one exemplary embodiment, the cyclodextrins are cyclodextrin derivatives formed by modifying cyclodextrins by methacrylates. The cyclodextrin derivatives have methacrylate groups, and have a chemical diagram of

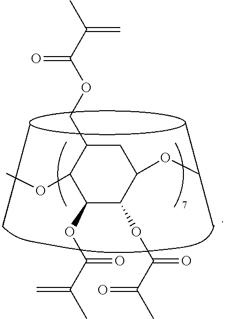

At block 103, a photochromic solution is prepared.

The photochromic solution can be prepared by adding the photochromic molecules to a solvent. The solvent can be ethanol, tetrahydrofuran, or acetone.

In at least one exemplary embodiment, the photochromic solution may have a concentration of about 0.0001 mol/L to about 0.01 mol/L.

At block 104, a cyclodextrin solution is prepared.

The cyclodextrin solution can be prepared by adding the cyclodextrins to water.

In at least one exemplary embodiment, the cyclodextrin solution may have a concentration of about 0.0001 mol/L to about 0.01 mol/L.

At block 105, the photochromic solution and the cyclodextrin solution are mixed to form a mixed solution.

The mixed solution is stirred to cause the photochromic molecules to be entrapped in the cavities of the cyclodextrins, thereby forming the photochromic molecule-cyclodextrin inclusion compounds. The photochromic molecule-cyclodextrin inclusion compounds retain photochromic properties.

In at least one exemplary embodiment, the photochromic solution and the cyclodextrin solution are mixed with equal volumes.

At block 106, the photochromic molecule-cyclodextrin inclusion compounds are separated from the mixed solution.

### EXAMPLE 1

A photochromic solution of 100 L was formed in which benzopyrylospiran had a concentration of 0.01 mol/L. A cyclodextrin solution of 100 L was formed in which cyclodextrin had a concentration of 0.01 mol/L. The photochromic solution and the cyclodextrin solution were mixed to form photochromic molecule-cyclodextrin inclusion compounds.

### EXAMPLE 2

A photochromic solution of 100 L was formed in which spiropyrans had a concentration of 0.01 mol/L. A cyclodextrin solution of 100 L was formed in which cyclodextrin had a concentration of 0.01 mol/L. The photochromic solution and the cyclodextrin solution were mixed to form photochromic molecule-cyclodextrin inclusion compounds.

The photochromic molecule-cyclodextrin inclusion compounds formed in example 1 and example 2 have hydrophilic characteristics.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A method for making photochromic molecule-cyclodextrin inclusion compounds, comprising:
providing photochromic molecules comprising hydrophobic groups;
providing cyclodextrins, a molecule of the cyclodextrin being hollow frusto-conical shaped and comprising a cavity;
adding the photochromic molecules to a solvent to preparing a photochromic solution;
adding the cyclodextrins to water to preparing a cyclodextrins solution;
mixing the photochromic solution and the cyclodextrin solution to form a mixed solution, the photochromic molecules being entrapped in the cavities of the cyclodextrins, thereby forming the photochromic molecule-cyclodextrin inclusion compounds; and
separating the photochromic molecule-cyclodextrin inclusion compounds from the mixed solution.

2. The method of claim 1, wherein the photochromic molecules is selected from a group consisting of spiropyrans, spiroperimidines, diarylethenes, fulgides, hexaarylbiimidazole, azobenzenes, benzopyrylospiran, and any combination thereof.

3. The method of claim 1, wherein the cyclodextrins are α-cyclodextrins, β-cyclodextrins, γ-cyclodextrins, cyclodextrin derivatives, or any combination thereof.

4. The method of claim 3, wherein the cyclodextrins are cyclodextrin derivatives formed by modifying cyclodextrins by methacrylates, the cyclodextrin derivatives have methacrylate groups, and have a chemical diagram of

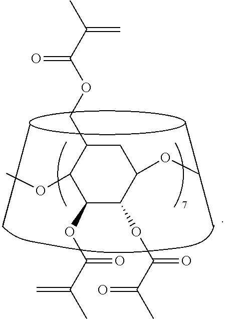

5. The method of claim 1, wherein the solvent is ethanol, tetrahydrofuran, or acetone.

6. The method of claim 1, wherein the photochromic solution has a concentration of about 0.0001 mol/L to about 0.01 mol/L.

7. The method of claim 1, wherein the cyclodextrin solution has a concentration of about 0.0001 mol/L to about 0.01 mol/L.

8. The method of claim 1, wherein the photochromic molecule-cyclodextrin inclusion compounds retain photochromic properties of the photochromic molecules.

9. The method of claim 1, wherein the photochromic solution and the cyclodextrin solution are mixed with equal volumes.

10. Photochromic molecule-cyclodextrin inclusion compounds, comprising:
photochromic molecules comprising hydrophobic groups; and
cyclodextrins, a molecule of the cyclodextrin being hollow frusto-conical shaped and comprising a cavity;
wherein the photochromic molecules is entrapped in the cavities of the cyclodextrins.

11. The photochromic molecule-cyclodextrin inclusion compounds of claim 10, wherein wherein the photochromic molecules is selected from a group consisting of spiropyrans, spiroperimidines, diarylethenes, fulgides, hexaarylbiimidazole, azobenzenes, benzopyrylospiran, and any combination thereof.

12. The photochromic molecule-cyclodextrin inclusion compounds of claim 10, wherein the cyclodextrins are α-cyclodextrins, β-cyclodextrins, γ-cyclodextrins, cyclodextrin derivatives, or any combination thereof.

13. The photochromic molecule-cyclodextrin inclusion compounds of claim 12, wherein the cyclodextrins are cyclodextrin derivatives formed by modifying cyclodextrins by methacrylates, the cyclodextrin derivatives have methacrylate groups, and have a chemical diagram of

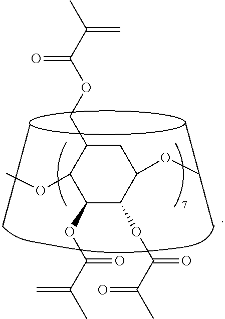

14. The photochromic molecule-cyclodextrin inclusion compounds of claim 10, wherein the photochromic molecule-cyclodextrin inclusion compounds remain photochromic properties of the photochromic molecules.
